(19) United States
(12) Patent Application Publication
(10) Pub. No.: US 2019/0230157 A1
(43) Pub. Date: Jul. 25, 2019

(54) METHODS AND SYSTEMS FOR WEB-BASED REMOTE CONTENT DISTRIBUTION

(71) Applicant: ARAM KOVACH, Westerville, OH (US)

(72) Inventor: ARAM KOVACH, Westerville, OH (US)

(21) Appl. No.: 15/878,931

(22) Filed: Jan. 24, 2018

(51) Int. Cl. H04L 29/08

(52) U.S. Cl. CPC H04L 67/1095; G06F 3/04842; H04L 67/02; H04L 67/141

(57) ABSTRACT

A method and system for web-based remote content distribution that may utilize Internet connections to provide one and/or two-way communication between a content distributer(s) and one or more users. The method and system can synchronize the distribution of the content to a plurality of users in one or more locations. The content may be auditory, visual, and/or tactile.

### TECHNICAL FIELD

The present disclosure relates generally to distribution of content among a plurality of remote devices. More specifically, the present disclosure relates to a web-based distribution scheme for distributing content to one or more remote devices.

### BACKGROUND

With the widespread adoption and use of internet-capable mobile devices (e.g., smart phones, tablets, and the like), individual users can connect with one-way or two-way digital content (“content”), such as a message, an article, an image, a song, a video, an advertisement, an offer, and the like. Such connections, in some applications, may require configuring the mobile devices with one or more specialized programs. To support the connections, mobile devices are required to allocate a portion of system resources (i.e., memory usage, processing power, etc.) to execute the one or more specialized programs. There are various device manufactures of internet-capable mobile devices as well as operating systems to execute the one or more specialized programs. To enable cross platform communication between the internet-capable mobile devices of various device manufacturers, servers may be employed with complex programs to handle movement of related data. Usage of such complex programs leads to a substantial increase in latency and makes synchronization of content between the mobile devices nearly impractical.

### SUMMARY

In an example, a system for web-based remote content distribution can include a master server having one or more processors and memory storing a master application and content. The one or more processors can retrieve the master application and execute the master application to issue a command. The system for web-based remote content distribution can further include a socket server communicatively coupled to the master server, and at least two client devices. The socket server can include one or more processors and memory storing a socket application. The one or more processors of the socket server can execute the socket application to establish, a WebSocket connection between a browser of each of the client devices and the socket server based at least on the command issued by the master server. The one or more processors of the socket server can further communicate the content from the master server to each of the browsers to each of the client devices via the WebSocket connection. The content can be synchronized to a master clock timing signal generated by the master server, and the browsers of each of the client devices may receive the content via the WebSocket connection.

In another example, a method for web-based remote content distribution can include storing, at a master server, content and issuing, at the master server, at least one command. The method can further include executing, on at least one socket server, automatically the at least one command and authenticating at least two client devices. The method can further include stablishing, at the least one socket server, a WebSocket connection between the socket server and a browser of each of the client devices based at least one the one command and distributing content via the WebSocket connection from the socket server to the browsers of the client devices. The content can be synchronized to a master clock timing signal generated by the master server.

In an even further example, a method for authenticating a client of a system for web-based remote content distribution can include displaying, at a client device associated with the client, a welcome screen on a browser of the client device and inviting the client to opt-in to the system. The method can further include receiving an agreement of the client to opt-in and establishing a WebSocket connection with the browser of the client device in response to an input at the client device. The method can further include distributing content automatically to the browser of the client device via the WebSocket connection.

### BRIEF DESCRIPTION OF THE DRAWINGS

FIG. 1A illustrates an example of a system for web-based remote content distribution.

FIG. 1B illustrates an example of a server for web-based remote content distribution.

FIG. 1C illustrates an example of a client device for web-based remote content distribution.

FIG. 1D illustrates a first example of web-based content displayed on a client device.

FIG. 1E illustrates a second example of web-based content displayed on a client device.

FIG. 1F illustrates a third example of web-based content displayed on a client device.

FIG. 1G illustrates a fourth example of web-based content displayed on a client device.

FIG. 2 illustrates an example of a method for web-based remote content distribution.

FIG. 3 illustrates an example of a method for authenticating a client of a system for web-based remote content distribution.

### DETAILED DESCRIPTION

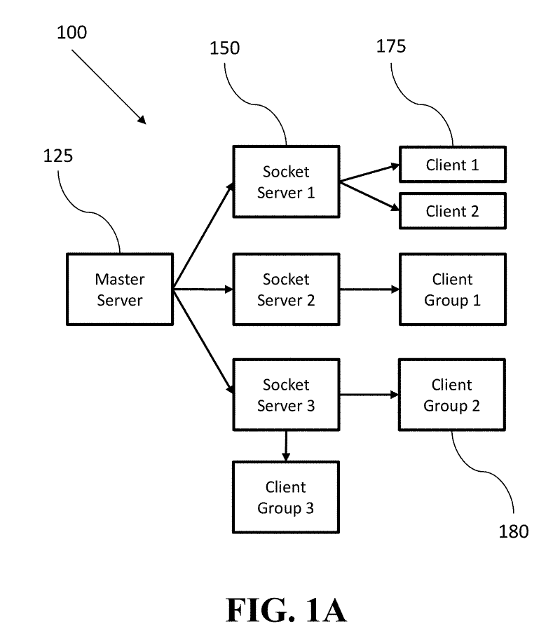

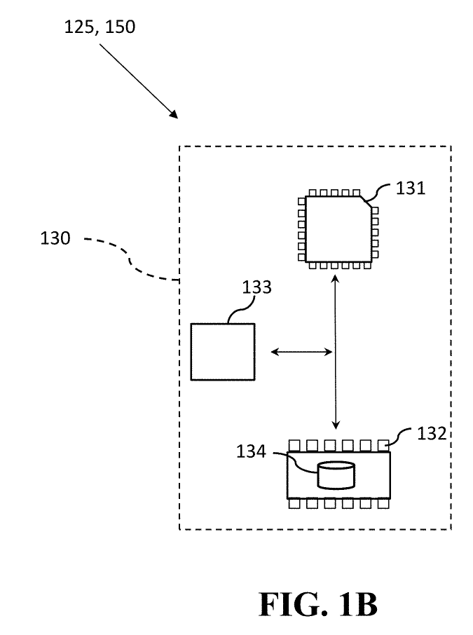

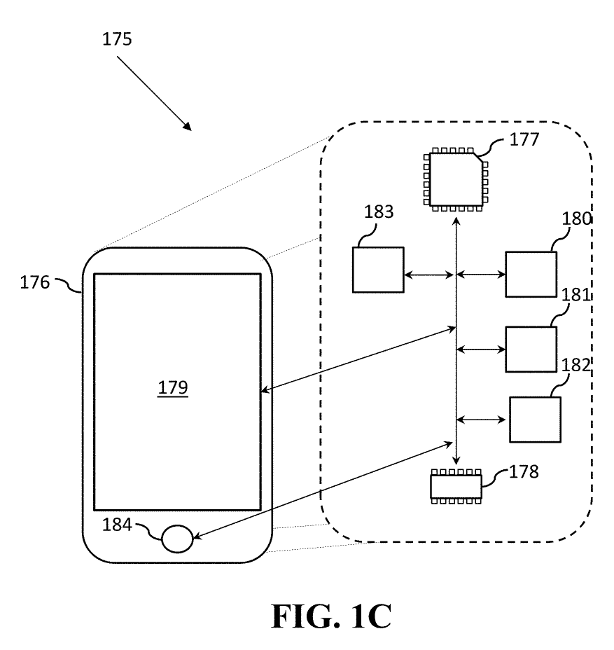

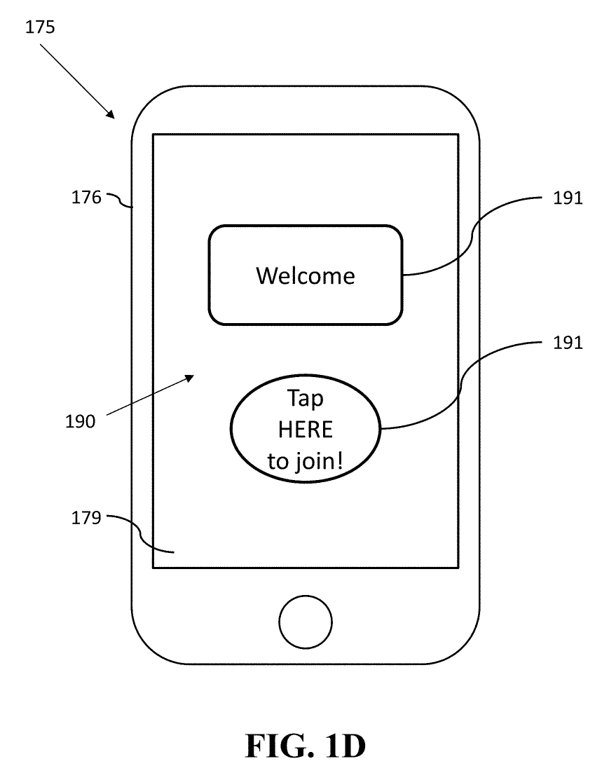

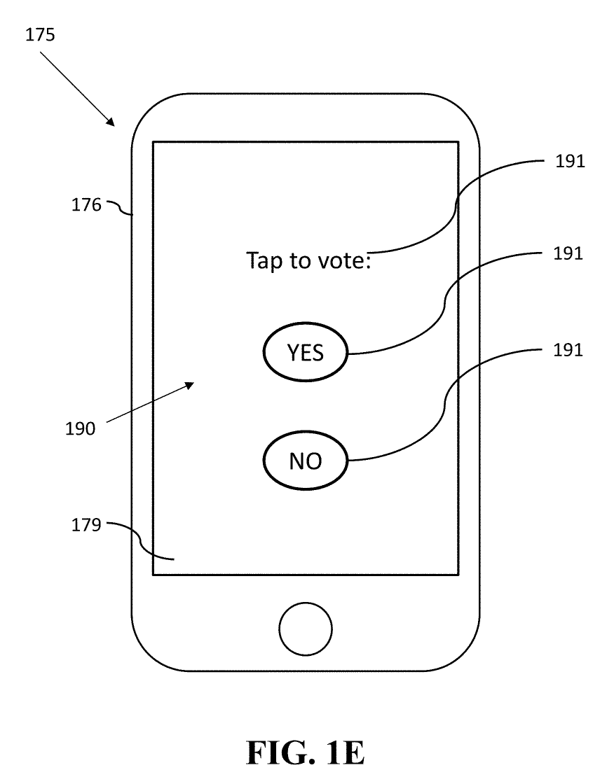

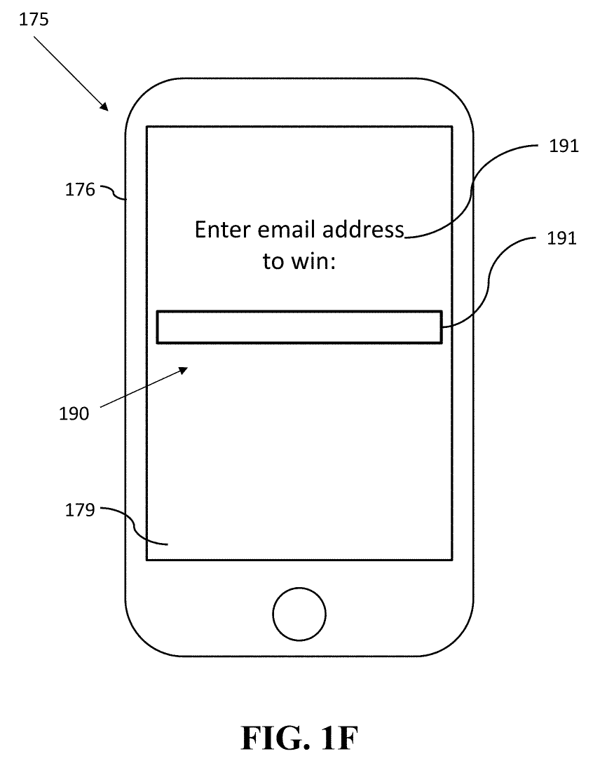

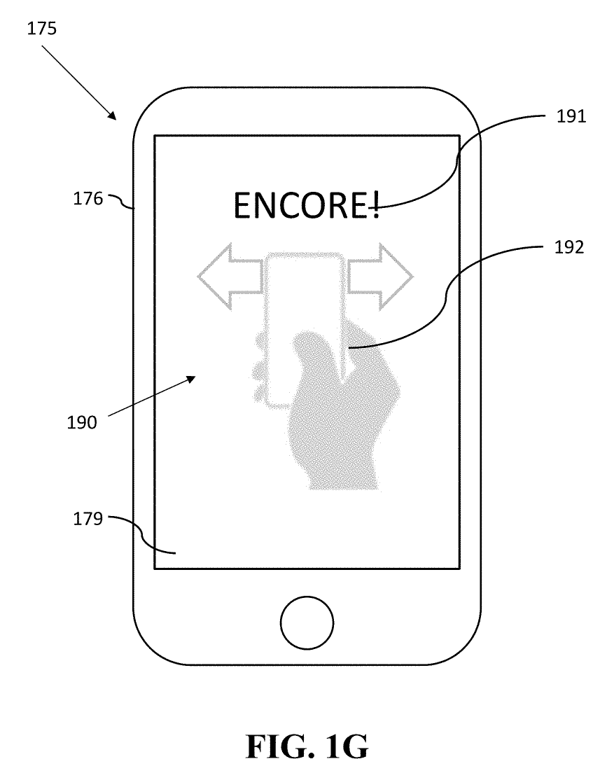

FIG. 1 illustrates an example of a system 100 for web-based remote content distribution. The system 100 can include a master server 125, at least one socket server 150, and at least one client 175. In one example, the system 100 can include a plurality of clients 175. One or more of the plurality of clients 175 can be grouped to form at least one client group 180. Thus, the system 100 can include a plurality of client groups 180. Additionally or alternatively, a client group 180 can include a plurality of client groups 180.

The master server 125 can be configured to execute at least one application. The at least one application can include a web server that hosts an administration console related to administrative functions of the system 100. Additionally or alternatively, the application can include a master clock that can be configured to provide a master timing signal to a socket server 150, client 175, client group 180, or a combination thereof. The master clock can be synchronized to a Network Time Protocol (“NTP”) server (not shown in FIG. 1). The master server 125 can further issue automatically at least one command to the socket server 150, client 175, client group 180, or a combination thereof.

The socket server 150 can be configured to execute at least one application. The at least one application of the socket server 150 can receive the master timing signal issued by the master server 125 and synchronize a local clock with a master clock signal of the master server 125 based the master timing signal. Thus, each local clock of each socket server 150 can be synchronized in time with the master clock of master server 125. In a further example, each socket server 150 can establish one or more connections with one or more clients 175 and forward at least one command from the master server 125 to the client 175 and/or to the client group 180.

The socket server 150 can be configured to execute at least one runtime environment, such as a Node.js® open-source, cross-platform runtime environment by Node.js Foundation and Joyent, Inc. Additionally, the socket server 150 can be configured for full-duplex (i.e., two-way) communication, for example, using a Transmission Control Protocol (“TCP”) to enable the exchanging data (e.g., data packets) bi-directionally between the master server 125 and the client 175 and/or to the client group 180. The socket server 150 can be configured to exchange the data over a single TCP connection. The socket server 150 can further include at least one Hyper Text Markup Language (HTML) 5 WebSocket library to facilitate the bi-directional communication over the single TCP connection.

WebSocket connections can improve a performance of a communication between two devices, such as the master server 125 and the client 175, by allowing these devices to communicate bi-directionally over a single connection (e.g., a single socket) rather than requiring two connections to be established. Utilizing a single connection between the these devices for bi-directional communication substantially reduces unnecessary network traffic and latency in contrast to utilizing two connections to provide the bi-directional communication.

Additionally or alternatively, the socket server 150 can be configured to automatically provide web server functionality. The socket server 150 can distribute content to at least one of the client 175 and client group 180. The socket server 150 can distribute web and/or other content to client 175 and/or client group 180 in response to establishing only a single connection between the socket server 150 and at least one of the client 175 and client group 180. Thus, a single connection can be utilized to facilitate the exchange of data (e.g., content) bi-directionally between the socket server 150 and at least one of the client 175 and the client group 180.

FIG. 1B illustrates an example of a physical server 130. The master server 125, socket server 150, or both can include the physical server 130. Alternatively or additionally, the master server 125, socket server 150, or both can be implemented in a virtual environment, as a virtual machine (e.g., a virtualization application). The physical server 130 can include one or more processors 131. The one or more processors 131 can be communicatively coupled to memory 132 of the physical server 130. The one or more processors 131 can further be communicatively coupled to a hardware network interface 133 of the physical server 130. The hardware network interface 133 enables the physical server 130 to communicate with one or more devices over an Internet. In one example, the hardware network 133 enables the physical server 130 to communicate with at least one of the client's 175 and client groups 180 over the Internet.

The physical server 130 may further include at least one database 134. The at least one database 134 can be communicatively coupled to at least one of the one or more processors 131 and memory 132. Although each of the one or more processors 131, the memory 132, the network interface hardware 133, and the database 134 are schematically depicted in FIG. 1B as being part of the physical server 130, such elements can be distributed over a plurality of machines (e.g., servers) that are communicatively coupled to one another. Accordingly, the physical server 130 can be scaled to include any number of hardware elements suitable for supporting any number of clients 175 and client groups 180.

In some applications, the one or more processors 131 can be configured to execute a web server program provided as machine readable instructions that can, for example, be stored in the memory 132. Exemplary web server programs can include, but is not limited to, Apache HTTP Server, Internet Information Services, Nginx, Google Web Server, and the like. Accordingly, the physical server 130 can be configured to utilize a server operating system such as, for example, Unix, Linux, BSD, Microsoft Windows, and the like.

FIG. 1C illustrates an example of a client (e.g., the client 175, as illustrated in FIG. 1A). The client 175 can include a smart phone 176. The description provided herein regarding the smart phone 176 is for clarity, and is not intended to limit the description to any specific machine. Various devices can be utilized without departing from the scope of the examples described herein such as, for example, a mobile phone, a tablet, a laptop computer, desktop computer, or a specialized device capable of communicating data over the Internet. The smart phone 176 can include one or more processors 177 that can be configured to execute machine readable instructions stored in memory 178 of the smart phone 176 to perform one or more functions according to the methods described herein. As used herein, the term “processor” can include any device capable of executing machine readable instructions. Accordingly, each processor can be a controller, an integrated circuit, a microchip, or any other device capable of implementing logic. Specific examples of the one or more processors 177 can include a touch screen controller, a baseband controller, a graphics processor, an application processor and an image processor.

The memory 178 of the smart phone 176 can be communicatively coupled to the one or more processors 177 (as depicted by the double arrowed lines in FIG. 1C). As used herein, the phrase “communicatively coupled” means that components are capable of exchanging data signals with one another such as, for example, electrical signals via conductive medium, electromagnetic signals via air, optical signals via optical waveguides, quantum entanglement, and the like. The memory 178 can correspond to one of random-access memory (RAM), read-only memory (ROM), flash memory, a hard drive, or any physical element capable of storing machine readable instructions. The smart phone 176 can be configured to implement a mobile operating system as machine readable instructions stored in the memory 178, which can be executed by the one or more processors 177. Specific examples of mobile operating systems include an Android, iOS, Blackberry OS, Windows Phone and Symbian.

The machine readable instructions stored in the memory 178 can be provided in any programming language of any generation (e.g., 1GL, 2GL, 3GL, 4GL, or 5GL) such as, e.g., machine language that may be directly executed by the one or more processors 177, or assembly language, object-oriented programming (OOP), scripting languages, microcode, etc., that may be compiled or assembled into machine readable instructions and stored on a machine readable medium. Alternatively, the functions, modules, and processes described herein may be written in a hardware description language (HDL), such as logic implemented via either a field-programmable gate array (FPGA) configuration or an application-specific integrated circuit (ASIC), and their equivalents. Accordingly, the functions, modules, and processes described herein may be implemented in any conventional computer programming language, as pre-programmed hardware elements, or as a combination of hardware and software components.

The smart phone 176 can further include a display 179 that can be communicatively coupled to the one or more processors 177. The display 179 can be controlled by the one or more processors 177 based on optical signals to illuminate pixels and provide visual feedback to users of smart phone 176. In some applications, the display 179 can be configured by the one or more processors 177 to selectively illuminate a portion of the plurality of pixels. The display 179 can include light emitting diodes (LEDs), organic-LEDs (OLEDs), liquid crystal display (LCD), liquid crystal on silicon (LCOS), or the like. Additionally, the display 179 can be configured to operate as a touch screen display for accepting tactile input via visual controls. Accordingly, the display 179 can include a touch detector such as, for example, a resistive sensor, capacitive sensor, and the like. The term “signal”, as used herein, can refer to a quantum state or a waveform (e.g., electrical, optical, magnetic, or electromagnetic), such as direct-current (DC), alternating current (AC), sinusoidal-wave, triangular-wave, square-wave, and the like, capable of traveling through a medium. The term “optical” can refer to various wavelengths of the electromagnetic spectrum such as, but not limited to, wavelengths in the ultraviolet (UV), infrared (IR), and visible portions of the electromagnetic spectrum.

The smart phone 176 can further include a hardware network interface 180 that can be communicatively coupled to the one or more processors 177. The hardware network interface 180 enables communicative coupling of the smart phone 176 to another device via a network such as, for example, a wide area network (WAN), a local area network (LAN), personal area network (PAN), a global positioning system (GPS) and combinations thereof. The hardware network interface 180 can be configured to communicate, e.g., send and/or receive signals via any wired or wireless communication protocol of a respective network to the other device. Thus, the hardware network interface 180 can be configured to communicate with the physical server 130.

The hardware network interface 180 can include any combination of an antenna, a modem, a LAN port, a wireless fidelity (Wi-Fi) card, a WiMax card, a near-field communication hardware and a satellite communication hardware over which communications can be facilitated between the smart phone 176 and the other device. Thus, the smart phone 176 can be communicatively coupled to a network via the WAN, LAN, PAN, a satellite network, and the like. Suitable LANs can include wired Ethernet and/or wireless technologies such as, for example, Wi-Fi. Suitable PANs can include wireless technologies such as, for example, Infrared Data Association (IrDA), BLUETOOTH, Wireless Universal Serial Bus (USB), Z-WAVE, ZIGBEE, and the like. Alternatively or additionally, suitable PANs may include wired computer buses such as, for example, USB and FIREWIRE. Thus, any components of the smart phone 176 may utilize one or more network components to communicate signals via the Internet or World Wide Web (WWW).

The smart phone 176 can further include radio frequency (RF) hardware (RF hardware) 181 that can be communicatively coupled to the one or more processors 177. The RF hardware 181 enables the smart phone 176 to communicatively couple with a cellular network. Suitable cellular networks include, but are not limited to, technologies such as Long-Term Evolution (LTE), Worldwide Interoperability for Microwave Access (WiMAX), Universal Mobile Telecommunication Service (UMTS), Code Division Multiple Access (CDMA), and Global System for Mobile Communications (GSM). In some examples, the RF hardware 181 can include components suitable for communicating voice information and data signals such as, for example, modems, attenuators, antennas, antenna switches, amplifiers, receivers, transceivers, or combinations thereof. Thus, the smart phone 176 described herein can employ a cellular network to communicate signals over the Internet or the WWW.

The smart phone 176 can further include a GPS receiver 182 that can be communicatively coupled to the one or more processors 177. The GPS receiver 182 can be configured to provide signals indicative of a location of the smart phone 176. For example, the GPS receiver 182 can receive signals encoded with location data, time data or both from a plurality of GPS satellites. The location of the smart phone 176 can be utilized in the examples described herein.

The smart phone 176 can further include an optical sensor 183 that can be communicatively coupled to the one or more processors 177 for detecting optical signals and encoding the detected signals into an image or collection of images (e.g., video). In some examples, the optical sensor 183 can include semiconductor charge-coupled devices (CCD), complementary metal-oxide-semiconductors (CMOS), N-type metal-oxide-semiconductors (NMOS), and the like. One or more images can be captured by the optical sensor 183. The optical sensor 183 can store the one or more captured images the memory 178.

The smart phone 176 can further include one or more input components 184 for sensing input (e.g., from a user of the smart phone 176) and encoding the sensed input into a representative signal. Suitable examples of input components 184 can include a microphone, a button, a knob, a switch, a resistive sensor, a capacitive sensor, a microphone, a keyboard, and the like. Additionally or alternatively or, the display 179 can be configured to receive a user input and operate as the input components 184. The smart phone 176 can further include one or more additional components in addition to the aforementioned components that can be communicatively coupled to the one or more processors 177 without departing from the scope of the examples described herein. Suitable additional components can include, but are not limited to, speakers, accessory lights, motion sensors, and the like.

Referring to FIG. 1A, the master server 125 may be configured to issue a command code (“command”), for example, via a master server user interface (“UI”). The command may be transmitted to at least one of the one socket server 150, the client 175, and at least one client group 180 through at least one WebSocket connection. The WebSocket connection may be established and/or facilitated by the socket server 150.

FIGS. 1D through 1G illustrate various examples of web-based content that may be displayed on a client device, such as the client device 175 of FIG. 1A or smart phone 176 of FIG. 1C. Referring to FIGS. 1D, the content can include at least one slide 190 that can be displayed on the client device 175. The slide 190 can include at least one element 191. The element 191 can include at least one of a text, an image, a color, a shape, a sound, a motion, a video, a URL, an HTML5 media element, and the like. The slide 190 can further include at least one full page element that includes the at least one element 191. The full page element may be a div generic flow container (“DIV”).

The slide 190 can further include at least one full page element, such as a DIV having dimensions that are a percentage of dimensions of the display 179. For example, the slide 190 may have a height of 100% of the height of screen 179 and a width of 100% of the width of the display 179. The client device 175 can be configured to automatically scale both the height and width of the at least one page element based on signals from the at least one socket server 150. The content of the slide can be configured in the administrative console. Thus, the administrative console can cause the at least one socket server 150 to generate signals that can configure the client device 175 to automatically scale both the height and width of the at least one page element.

In one example, as illustrated in FIG. 1E, the slide 190 can include one or more elements 191 that can request that a user interact with the client device 175. For example, the slide 190 can display the one or more elements 191 that can include text and/or graphics that illicit user interaction with the client device 175. The text and/or graphics can include a statement (e.g., “Tap to Vote:”, as illustrated in FIG. 1E) and a plurality of options (e.g., YES and NO, as illustrated in FIG. 1E) associated with the statement.

In the example of FIG. 1E, the slide 190 includes texts and/or graphics requesting that the user interact (i.e., “tap”) with the client device 175 to cast a vote. The user can cast the vote, for example, by interacting with the display 179 by touching (tapping) the display 179 at a location corresponding to a desired option. The system 100 may be configured to collect statistics of the user votes and display or record the statistics. In another example, the slide 190, as illustrated in FIG. 1F, can display an element 191 corresponding to a user input field and request that the user to enter an email address to enter a drawing for a chance to win a prize. Additionally or alternatively, the slide 190 can display an element 191 corresponding to a user input field and ask the user to enter a phone number to receive a coupon code, for example, in the near-by future.

In addition to voting statistics, the system 100 can collect any number of statistics, including but not limited to, the following statistics a platform of client device 175 (e.g., a desktop, a laptop, a mobile device, etc.), a make and model of the client device 175 (e.g., an Apple iPhone® 6, a Samsung Galaxy® S7, etc.), an operating system and corresponding version of the client device 175 (e.g., Windows®, iOS®, Android®, etc.), a total number of unique client devices 175, and a maximum of concurrent client devices 175 connected to system 100 (e.g., in communication with the master clock 125, the socket server 150 or a combination thereof).

Referring to FIG. 1G, the at least one slide 190 can further include content that contains an overlay 192. The overlay 192 can be created by additional DIVs that appear upon a change from a first slide to a second slide, for example, in response to user input at the client device 175. For instance, the first slide can include a first DIV and the second slide can include a second DIV. Upon a change from the first slide to the second slide, a third DIV can appear for a predetermined amount of time, which can be user defined or determined according the content, and then disappear. For example, the third DIV can include the overlay 192. The overlay 192 can include instructions directing the user to perform an action, such as moving the client device 175 from one location in an environment in which the client device 175 is located to another location in the environment. For instance, the instructions may direct the user to wave the client device 175 from side to side. Additionally or alternatively, the instructions can further direct the user to change an orientation of the client device 175. The overlay 192 can be a transparent Graphical Interchange Format (GIF) image or icon overlay.

The content can further include a series of slides and/or overlays that can be configured to play-out in a specified order with user-configurable intervals, in accordance with a timed script. For example, a first slide can be displayed on the client device 175, an overlay can be displayed on the client device 175 after five seconds, a second slide can be displayed on the client device 175 after an additional fifteen seconds, and so on.

In an example, the system 100 can be configured to communicate simultaneously with a plurality of users of the plurality of client device 175 in order to coordinate at least one activity. For example, the system 100 can be configured to coordinate a gathering of people at an event (e.g., a concert, a shopping mall, and the like) in a time of need, such as severe storm, structure fire, active shooter, terror threat, and the like. The system 100 can provide alerts to the client devices 175 present during the time of need such that the plurality of users of the plurality of client device 175 can be instructed regarding safety, egress, aid, and the like. For example, the system 100 can notify concertgoers of an active shooter at a concert venue and alert the concertgoers, by way of their respective client devices 175, to seek safety. Furthermore, system 100 can provide the concertgoers with details regarding egress of the venue, nearby areas of safety, and the like.

Additionally, the system 100 can be configured to only provide a subset of the client devices 175 with alerts. For example, in the time of need, the system 100 can provide the alert to a portion of the users that are within a given distance of a need causing event. The system 100 can determine a location of the client devices 175 and their respective distances to the need causing event. The system 100 can evaluate the locations of the client devices 175 relative to the need causing event to determine which of the client devices 175 (corresponding to the subset of the client devices 175) to provide with alerts. This evaluation can be relative to a distance threshold. Thus, the system 100 can provide the alerts to the subset of client devices 175 that are within, for example, 10 meters (m) of the need causing event. By alerting a portion of the client devices 175 substantially reduces loading of a network (e.g., wired/wireless network) that the client devices 175 are configured to receive the alerts. Additionally or alternatively, the system 100 can transmit a location of the subset of client devices to 175 to a third-party (e.g., police).

The administrative console can allow an administrator to define, configure, and control content that is provided on the client device 175. The administrative console can be a web page. The administrative console can be a responsive web page. An administrator can have access to the administrative console according to an assigned access level. Administrators with higher assigned access levels can have access to more options/functions of than administrators with lower assigned access levels. Administrators can have a level of control over aspects of the system 100, for example, according to an assigned access level. For example, some administrators can have partial control over the system 100 while other administrators can full control over the system 100. Administrators can have control over one or more of the following aspects of system 100 according to a respective assigned access level: creating other users having any access level; managing events, content, users, and the like; managing slides (e.g., adding, editing, and deleting slides, overlays, and timed scripts); viewing statistics for any event; and any other aspect.

Administrators can further create client-level users. A client level user can have less access to aspects of system 100 than administrators. Additionally or alternatively, administrators can further create technician-level users. A technician-level user can have less access to aspects of system 100 than the administrators Client-level users can have control over the following aspects of system 100 creating technician-level users (e.g., a band manager may add a lighting technician to synchronize concert lighting and pyrotechnics with system 100), assigning technician-level users to an event, controlling slides at an event; managing events (e.g., adding, deleting, and editing), managing slides for any of their own events, viewing statistics for any of their own events, starting, stopping, and pausing timed scripts and executing random drawings of winners when slides contain user data collection Technician-level users can have control over the following aspects of system 100 logging in and controlling slides for active events in accordance with access levels, starting, stopping, and pausing timed scripts and executing random drawings of winners when slides contain user data collection.

The system 100 can be configured to manage a single event (e.g., vote casting, as illustrated in FIG. 1E). Alternatively, the system 100 can manage simultaneously a plurality of events. In order to ensure that client device 175 has access to a correct event, a user can access system 100 from the client device 175 by opening a URL that directs the user to the content for the correct event. Information related to an event (e.g., the least one command signal generated by the master server 125) can be transmitted between the master server 125 and each of the client devices 175 via the WebSocket connection established and/or facilitated by the socket server 150. Thus, only a single connection is employed to provide bi-directional communication between the master server 125 and the client device 175.

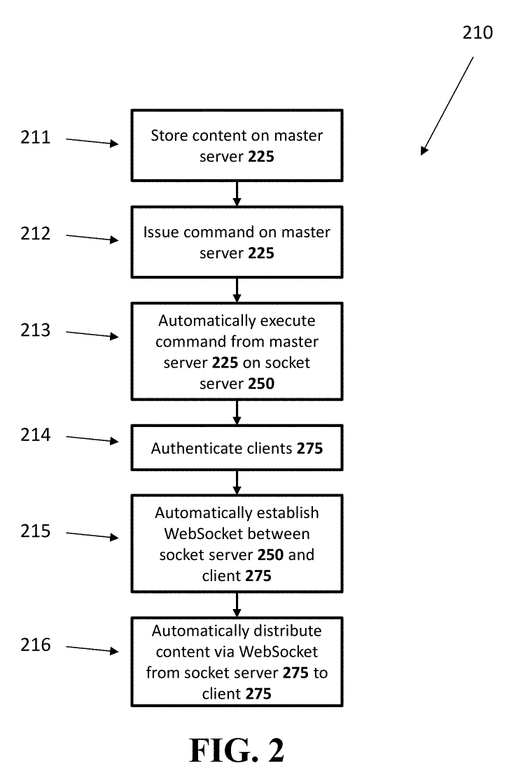

FIG. 2 illustrates an example of a method 210 for a web-based remote content distribution. The method 210 can include includes: a first step 211 of storing content on a master server 225; a second step 212 of issuing at least one command on the master server 225; a third step 213 of executing automatically the command from the master server 225 on at least one socket server 250; a fourth step 214 of authenticating at least two clients 275; a fifth step 215 of automatically establishing a WebSocket connection between the socket server 250 and a browser of each of the client's 275; and a sixth step 216 of automatically distributing content via the WebSocket connection from socket server 250 to the browsers of clients 275. Distribution of the content can be according to a master clock timing signal generated by the master server 225.

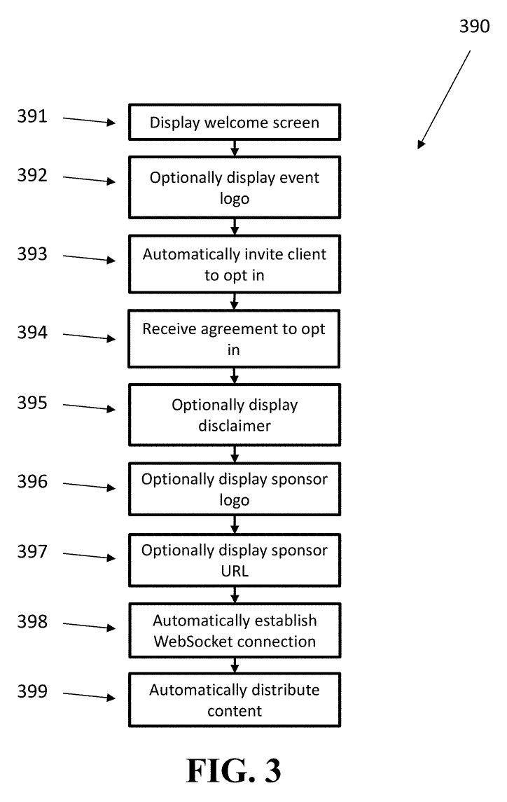

FIG. 3 illustrates another example of a method 390 for authenticating a client device (e.g., the client device 175, as illustrated in FIG. 1A) of a system (e.g., the system 100, as illustrated in FIG. 1A) for a web-based remote content distribution. The method 390 can begin with a display of a welcome screen 391 on a browser of the client device at an event. A client user of the client device can access the welcome screen 391 on the client device by accessing a URL (e.g., the URL can be provided from the master server 125 or another server). The client user can access welcome screen 391 by 1) sending an electronical mail or text message to an electronic mail address or to a telephone number designated for the event, and 2) accessing a URL provided to the client device in response to the electronic mail or the text message. The client user can access the welcome screen 391 by 1) taking a photograph of a sign, a display, or the like at the event; 2) sending a text message of the photograph to a telephone number designated for the event; and 3) accessing a URL provided to the client device in response to the text message. The client user can access the welcome screen 391 at least in part by a method, as described in at least one of U.S. patent Ser. No. 12/860,883 and U.S. Pat. No. 8,335,491, both of which are incorporated herein by reference.

The client user can be presented with an optional event logo 392. The optional event logo 392 can be displayed at the same time welcome screen 391 is displayed, or after welcome screen 391 is displayed. The client user can be presented automatically with an invitation to opt-in 392 to authentication at the same time welcome screen 391 is displayed, or after welcome screen 391 is displayed. The client user can agree to opt-in 394. The client user can be presented with an optional disclaimer 395 upon agreeing to opt-in 394. The client user can be presented with an optional sponsor logo 396 after agreeing to opt-in 394. The client user can be presented with an optional sponsor URL 397 after agreeing to opt-in 394. A WebSocket connection 398 can be automatically established with the browser of the client device. Content 399 can be distributed automatically to the client device via the WebSocket connection 398 after the client agrees to opt-in 394.

The content can include at least one slide that contains an overlay. The overlay can be created by a DIV that appears upon a change from a first slide to a second slide. For example, the first slide can include a first DIV and the second slide can include a second DIV. Upon a change from the first slide to the second slide, a third DIV may appear for a predetermined amount of time and then disappear. For example, the third DIV can include an overlay. The overlay can provide instructions to a user to perform an action, such as waving a phone from side-to-side. The overlay can be a transparent GIF image or icon overlay.

The content can further include a series of slides and/or overlays that can be configured to play in a specified order with user-configurable intervals, such as by a timed script. For example, a first slide can be displayed, an overlay can be displayed after five seconds, a second slide can be displayed after an additional fifteen seconds, and so on.

It may be desirable to connect a plurality of users, who are gathered at a single location (e.g., a concert, a speech, a political rally, and the like) with content. Furthermore, it may be desirable to synchronize or otherwise coordinate content among the plurality of users gathered at one location. For example, users gathered at a concert may enjoy receiving an image of a lighter on their phones to display during an encore. Similarly, these concertgoers may enjoy being able to use their phones to recommend or vote for a particular song to be performed for the encore.

Content may be synchronized on a plurality of personal mobile devices (“clients”) associated with the plurality of users in the following manner: content can be stored on a server (e.g., the master server 125, as illustrated in FIG. 1A); an application program can be installed on the server and configured to distribute can content to a client (e.g., the client 175, as illustrated in FIG. 1A); an application program can be installed on the client and be configured to communicate with and receive content from the server; and content can be distributed from the server to the client. However, distributing content to clients in accordance with this manner requires a specialized program on each client so that the content from the server can be received. What is needed is a manner in which content can be distributed simultaneously to a plurality of clients without requiring the clients to execute a specialized program.

According to the examples provided herein, the system can provide a service through a WebSocket that can be established using a web browser on a client. The WebSocket allows for bi-directional communication between a socket server and the web browsers of the clients, such that content can be distributed to the clients in synchronization with a master clock timing signal and in response to commands communicated by a master server. Because the WebSocket establishes a channel for the content to be delivered directly to the web browsers of the clients, there is no need for a specialized application to be running on the clients. As a result, the present examples allow the clients to consume less memory, i.e., no need to store a specialized application. Moreover, the service may not be dependent upon the operating systems running on the clients, and thus users may receive the service independent of the client devices deployed by the users. Additionally, since the content may be delivered via a WebSocket either prior to use or as needed, a more unified experience can be provided via multiple synchronized clients. For example, if multiple clients are in a single location (e.g., a concert), content may be displayed on each client with less time lag from the master clock timing signal compared to known communication methods (e.g., multiple clients running a specialized application to receive content). Thus, each of the clients can be configured to generate media elements substantially simultaneously, i.e., in step with the other clients.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available in the art. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of examples thereof, and while the examples have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to.

What is claimed is:

1. A system for web-based remote content distribution, comprising:
a master server comprising one or more processors and memory, wherein the memory comprise a master application and content, and wherein the one or more processors executes the master application to issue a command; and
a socket server coupled to the master server and at least two client devices, wherein the socket server comprises one or more processors and memory storing a socket application, the socket server configured to execute the socket application to:
establish, responsive to the command, a WebSocket connection between a browser of each of the client devices and the socket server; and
communicate the content from the master server to the browsers of the client device, wherein the content is synchronized to a master clock timing signal generated by the master server, and wherein the browsers of each of the client devices receive the content via the WebSocket connections.

2. The system of claim 1, wherein the content comprises at least one of: a slide, a text, an image, a color, a shape, a sound, a motion, a video, a URL, and an HTML5 media element.

3. The system of claim 2, wherein the slide comprises at least one full page element configured to display on the client, and wherein at least one of the socket server and the client is configured to automatically scale both the height and width of the at least one full page element displayed on the client.

4. The system of claim 2, further comprising a plurality of slides, wherein the plurality of slides comprise at least one of: an overlay and a timed script.

5. The system of claim 1, further comprising at least one client group comprising a plurality of clients, and wherein at least one of the clients is a smart phone.

6. A method for a web-based remote content distribution, comprising:
storing, at a master server, content;
issuing, at the master server, at least one command;
executing, on at least one socket server, the command issued by the master server;
authenticating, at the at least one socket server, at least two client devices;
automatically establishing a WebSocket connection between the socket server and a browser of each of the client devices; and
distributing content via the WebSocket connection to the browsers of the clients, wherein the content is synchronized to a master clock timing signal generated by the master server.

7. The method of claim 10, wherein the content comprises at least one of: a slide, a text, an image, a color, a shape, a sound, a motion, a video, a URL, and an HTML5 media element.

8. The method of claim 11, wherein the slide comprises at least one full page element configured to display on the client, and wherein at least one of the socket server and the client device is configured to automatically scale both the height and width of the at least one full page element displayed on the client device.

9. The method of claim 11, further comprising a plurality of slides, wherein the plurality of slides comprise at least one of: an overlay and a timed script.

10. The method of claim 10, wherein the client device is a plurality of client devices, and wherein at least one client device is a smart phone.

11. The method of claim 16, wherein the plurality of client devices further comprises at least one client device group.

12. A method for authenticating a client of a system for web-based remote content distribution, comprising:
displaying a welcome screen on a browser of a client device of a client;
automatically inviting the client to opt in to the system via the client device;
receiving an agreement of the client to opt in in response to client input at the client device; and
automatically establishing a WebSocket connection with the browser of a client device of the client; and
distributing automatically content to the browser of the client device via the WebSocket connection.

13. The method of claim 18, further comprising: displaying an event logo on the client device either at the same time the welcome screen is displayed, or after the welcome screen is displayed.

14. The method of claim 18, further comprising: displaying at least one of: a disclaimer, a sponsor logo, and a sponsor URL on the client device upon the agreement of the client to opt in.
